(19) United States
(12) Patent Application Publication
(10) Pub. No.: US 2026/0120967 A1
(43) Pub. Date: Apr. 30, 2026

(54) DISCONNECTOR CONTACT SYSTEM WITH CONTROLLED DISCHARGE

(71) Applicant: Hitachi Energy Ltd, Zürich (CH)

(72) Inventors: Ulrich STRAUMANN, Winterthur (CH); Markus M. Keller, Winterthur (CH); David SAXL, Zürich (CH); Diego Felipe SOLOGUREN-SANCHEZ, Wettingen (CH)

(21) Appl. No.: 19/470,584

(22) PCT Filed: Feb. 15, 2024
(86) PCT No.: PCT/EP2024/053798

§ 371 Date: Sep. 29, 2025

(30) Foreign Application Priority Data
Mar. 30, 2023 (EP) 23165607.5

(51) Int. Cl. H01H 1/06; H01H 1/02; H01H 33/06; H01H 33/12

(52) U.S. Cl. CPC H01H 1/06; H01H 1/02; H01H 33/06; H01H 33/12

(57) ABSTRACT

Embodiments herein provide a gas-insulated disconnector for an electrical apparatus that includes a first contact having a longitudinal center axis and a second contact. At least one of the first contact and the second contact is movable in a direction of the longitudinal center axis of the first contact, where the first contact is connected to the second contact in a closed position and disconnected from the second contact in an open position. The second contact includes a pre-determined contact portion that has a roughness higher than a roughness of neighbouring contact portions of the second contact, where the pre-determined contact portion is closer to the longitudinal center axis of the first contact than are the neighbouring contact portions.

### CROSS REFERENCE TO RELATED APPLICATIONS

This application is a 35 U.S. C. § 371 national stage application of International Application No. PCT/EP2024/053798 filed on Feb. 15, 2024, which in turn claims foreign priority to European Patent Application No. 23165607.5 filed on Mar. 30, 2023, the disclosures and content of which are incorporated by reference herein in their entirety.

### TECHNICAL FIELD

The present disclosure generally relates to a gas-insulated high voltage device. More particularly, it relates to a contact system of a switching device with controlled discharge root point.

### BACKGROUND

A switching apparatus is used for isolating electrical devices from a power line or to disconnect a section of power line from another. The switching apparatus includes a disconnector switch, DS, (for example, a vertical break disconnector) and/or an earthing switch. The DS is a mechanical switch adapted for connecting or disconnecting the electrical devices from the power line. The DS is typically used in high voltage environment to form a visible disconnecting point to ensure a reliable isolation of the electrical devices from the power line, such that the electrical devices can be operated or maintained safely without a load. The DS 100, as depicted in FIG. 1, has a contact system comprising two contacts, a moving contact 110 and a fixed contact 120 placed in a closed chamber. In normal conditions, the two contacts 110 and 120 remain connected (i.e., a closed position). When the DS is desired to disconnect a part of the switchgear, the two contacts 110 and 120 separate (i.e., an open position) to interrupt an electrical circuit.

Generally, with the disconnector 100 under service voltage applications, during switching operations (for example, bus-charging switching currents), the moving contact 110 is switched between the closed position and the open position. Due to the acting of the moving contact 110, a spark or capacitive discharges (i.e., pre-strike or restrike discharges) may be formed between the two contacts 110 and 120 in a case of bus-charging current switching. For example, during closing, the spark may be formed before the moving contact 110 has reached/touched the fixed contact 120. During opening, the spark may be formed before the moving contact 110 has reached the fully open position. Further, a current continues to flow between the two contacts 110 and 120 through the spark. The closed compartment in which the two contacts 110 and 120 have been placed may contain a fluid insulating medium (either liquid or gas), which quenches/extinguishes the spark formed between the two contacts 110 and 120.

Further, under certain conditions, the formed discharges/spark may cause disruptive discharges from the contact system of the disconnector to enclosure (i.e., ground potential), which leads to an internal spark and failure of the DS. For example, the discharges/spark (i.e., pre-strike or restrike discharges) formed between the contacts 110 and 120 of a partially closed contact system is depicted in FIG. 1, wherein the moving contact 110 is fixed at a certain position under multiple voltage applications.

With existing designs of the contact system of the disconnector 100 as described above, the discharges/spark may often start at locations of or near a front edge (tip) of the moving contact 110, wherein locations of the moving contact 110 may close to or even on an outer tube surface of the moving contact 110. Thus, such discharges may have a higher probability of leading to disruptive spark/discharges to the enclosure than discharges/spark starting closer to an inner tube surface of the moving contact 110.

In addition, the spark/discharges formed between the contacts 110 and 120 may get in contact with the closed chamber or any other element of the DS that may be at the enclosure/ground potential, thereby damaging elements of the disconnector 100/DS. For example, how the spark propagates and establishes the contact with the closed chamber or any other element of the DS that may be at the enclosure/round potential is depicted in FIGS. 2A, 2B, 2C, and 2D.

### SUMMARY

With existing designs of the disconnector of the DS, the spark may start at a location of or near to a front edge of the moving contact edge, which is close to or even on an outer surface of the moving contact. Such a spark has a higher probability of getting in contact with the closed chamber of the DS or any other element of the DS that is at the ground potential as compared to a spark that may start closer to an inner surface or to a longitudinal center axis of the moving contact.

The likelihood of such undesired acentric discharges is larger under the instant, where the moving contact is stressed with positive potential during the bus-charging current switching duty. In this configuration, due to lacking first-electron to initiate the discharge, the discharge root-points may spread wider on the moving contact. Due to statistical reasons, the discharge may occur at undesired acentric locations.

In most of cases, any of the two contacts of the disconnector are not specially designed and therefore the spark may start from an undesirable point on the moving contact. Therefore, it is difficult to limit the spark to remain at an axial centre of the disconnector and further it is difficult to avoid the contact of the spark with the chamber or any other element of the DS that may be at the ground potential.

The problem of the lack of the first-electron to initiate the discharge on the positively stressed moving contact may overcome by providing the first electron from the negatively stressed fixed contact-side by field emission.

Consequently, there is a need for a disconnector with at least one of two contacts designed in such a way that a spark is limited to remain at an axial centre of the disconnector, thereby avoiding a contact of the spark with a closed chamber or any other element of a DS that may be at a ground potential.

It is therefore an object of the present disclosure to provide a disconnector for an electrical apparatus, to mitigate, alleviate, or eliminate all or at least some of the above-discussed drawbacks of presently known solutions.

This and other objects are achieved by means of a disconnector as defined in the appended claims. The term exemplary is in the present context to be understood as serving as an instance, example or illustration.

According to an aspect of the present disclosure, a disconnector for an electrical apparatus is provided. The disconnector comprises a first contact having a longitudinal center axis and a second contact, wherein at least one of the first contact and the second contact is movable in a direction of the longitudinal center axis of the first contact, wherein the first contact is connected to the second contact in a closed position, wherein the first contact is disconnected from the second contact in an open position, wherein the second contact comprises a pre-determined contact portion that has a roughness higher than a roughness of neighbouring contact portions of the second contact, and wherein the pre-determined contact portion is closer to the longitudinal center axis of the first contact than are said neighbouring contact portions.

A field emission to happen may require appropriate roughness on either of the first contact or the second contact. Ions generated by the field emission may drift along field lines to the other contact, where they may detach the electron and initiate the spark/discharge.

Advantageously, with the proposed disconnector, the discharges/spark formed between the two contacts may occur closer to the longitudinal center axis of the first contact when such increased roughness on the FC-side is implemented at location, where the negative ions will be transported to the location, where initiation of the discharges on the MC are being desired. As a result, shielding effect of fixed electrodes at the first contact and the second contact on a discharge channel may be maximized.

Further, with the proposed disconnector, a risk of disruptive discharges (i.e., pre-strikes or restrikes formed between the two contacts) to enclosure (i.e., ground potential) may be reduced during switching of bus-charging current switching. The risk of disruptive discharges may be reduced by centring a path of the discharges/spark closer to the longitudinal center axis of the first contact.

In some embodiments, a minimum roughness of the pre-determined contact portion of the second contact has an Arithmetic average roughness value, Ra of 1 microns, Total height of the roughness profile, Rt of 8 microns, and a Mean roughness depth, Rz of 4 microns.

In some embodiments, a minimum roughness of the pre-determined contact portion of the second contact has an Arithmetic average roughness value, Ra of 2 microns, Total height of the roughness profile, Rt of 15 microns, and a Mean roughness depth, Rz of 7 microns.

In some embodiments, a minimum roughness of the pre-determined contact portion of the second contact has an Arithmetic average roughness value, Ra of 5 microns, Total height of the roughness profile, Rt of 30 microns, and a Mean roughness depth, Rz of 20 microns.

In some embodiments, a maximum roughness of the pre-determined contact portion of the second contact has an Arithmetic average roughness value, Ra, of 20 microns, Total height of the roughness profile, Rt, of 120 microns, and a Mean roughness depth, Rz, of 80 microns.

In some embodiments, a maximum roughness of the pre-determined contact portion of the second contact has an Arithmetic average roughness value, Ra, of 15 microns, Total height of the roughness profile, Rt, of 90 microns, and a Mean roughness depth, Rz, of 60 microns.

In some embodiments, a maximum roughness of the pre-determined contact portion of the second contact has an Arithmetic average roughness value, Ra, of 10 microns, Total height of the roughness profile, Rt, of 60 microns, and a Mean roughness depth, Rz, of 40 microns.

In some embodiments, the first contact has an end surface directed towards a second contact, and wherein in said open position, the pre-determined contact portion of the second contact is closest to the first contact as compared to other contact portions of the second contact.

In some embodiments, the first contact is movably arranged in the direction of the longitudinal center axis, and wherein the second contact is a fixed contact.

In some embodiments, the pre-determined contact portion having the increased roughness is constituted by an Aluminium alloy.

In some embodiments, the pre-determined contact portion having the increased roughness is defined by a circular area having a center axis, which is in alignment with the longitudinal center axis of the first contact, and wherein the circular area has a radius, which is less than a radius of an outer periphery of the first contact.

In some embodiments, the radius of the pre-determined contact portion is less than a radius of an inner periphery of the first contact.

In some embodiments, the disconnector comprises a dielectric shield that encloses the first contact. The dielectric shield extends to an end region of the first contact adjacent the second contact. The disclosure, by directing sparks to the centre (inner periphery) of the first contact portion rather than to the outer periphery thereof, prevents degradation of the shield due to sparks reaching the latter.

In some embodiments, the disconnector comprises an insulating medium between the first contact and the second contact, wherein the insulating medium comprises at least one of Sulphur hexafluoride, SF₆, air, Carbon dioxide, CO₂, Oxygen, O₂, a fluoroketone mixture, and a nitrile mixture.

In some embodiments, one or more of the first contact and the second contact is tubular. Advantageously, with the proposed arrangement of the first contact and the second contact and a special design of an electrode geometry of the first contact, the discharges/spark may be generated from the pre-determined contact portion. Thereby, centralizing a path of the discharges/spark by shifting it closer to the longitudinal center axis of the first contact.

Other advantages may be readily apparent to one having skill in the art. Certain embodiments may have some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses a schematic diagram of an example disconnector according to the prior art;

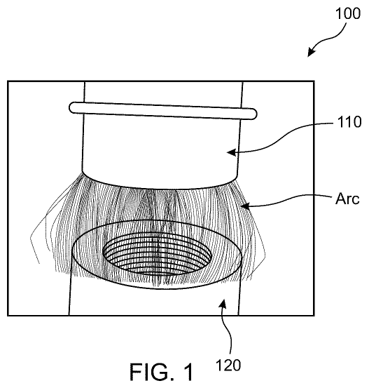

FIGS. 2A, 2B, 2C, and 2D disclose an example path followed by a spark to establish contact with a closed chamber or any other elements of a disconnector switch, DS, that are at enclosure/ground potential according to the prior art;

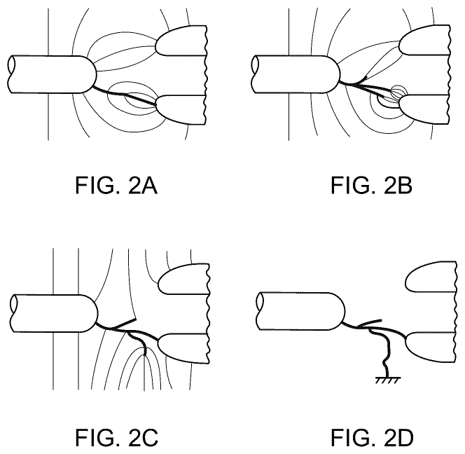

FIG. 3 discloses a schematic diagram illustrating an example disconnector according to some embodiments; and

FIG. 4 discloses a schematic diagram illustrating an example disconnector according to some embodiments.

### DETAILED DESCRIPTION

Aspects of the present disclosure will be described more fully hereinafter with reference to the accompanying drawings. The DS disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the disclosure. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

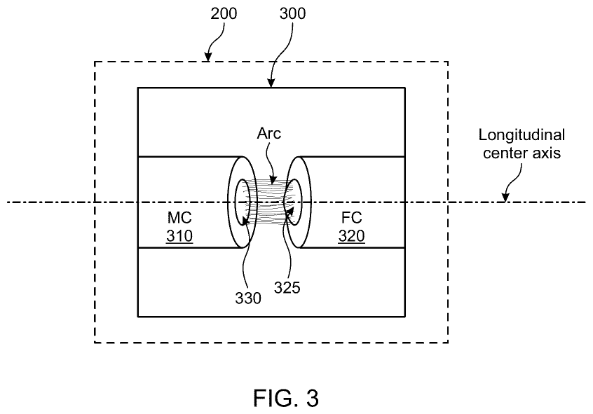

FIG. 3 discloses a schematic diagram of an example disconnector 300. The electrical apparatus 200 may be a Disconnector Switch, DS. The DS may be a switching device capable of making, conducting, and breaking current in an electrical circuit in normal conditions. The DS may also be configured for making, conducting for a specified period, and automatically breaking current in the electrical circuit under specified abnormal conditions. In an example, the specified abnormal conditions may be a short-circuit fault.

The disconnector 300 referred herein may be adapted for an electrical apparatus 200. The disconnector 300 may be a Gas Insulated Switchgear, GIS, disconnector or a mixed technology switchgear, MTS, which is a combination of components of air insulated switchgear, AIS, or a combination of the AIS and the GIS disconnector. The disconnector 300 comprises a contact system with at least two contacts, a first contact 310 and a second contact 320. At least one of the two contacts, i.e. the first contact 310 or the second contact 320 may be of a tubular shape, tubular shape being long, round, and hollow, like a tube. In an example, as depicted in FIG. 3, the first contact 310 is of the tubular shape. The at least one of the two contacts, whichever is configured to move is a moving contact, MC, for example, the first contact 310 and other one of the two contacts may be a fixed contact, FC, for example, the second contact 320. Thus, in some embodiments described herein, the terms first contact, moving contact, and MC are used interchangeably. Similarly, the terms second contact and FC are used interchangeably.

The two contacts 310 and 320 are conductors of electricity and may be on electrical potential while the DS is in operation. The first contact 310 and the second contact 320 may be placed in a closed chamber. The closed chamber may contain a fluid insulating medium (either liquid or gas).

During switching operations (for example, bus-charging switching currents), the first contact 310 is switched between the closed position and the open position. Due to the switching of the first contact 310, a spark or discharges (i.e., pre-strikes or restrikes discharges) may be formed between the first contact 310 and the second contact 320. The fluid insulating medium in the closed chamber quenches/extinguishes the spark. The insulating medium in the DS in which circuit interruption is performed may be one or more of, but is not limited to, oil, air-break, air-blast, sulphur hexafluoride (SF₆), eco gases (air, CO₂, O₂, etc.), vacuum, and so on.

More specifically, among the two contacts, when the first contact 310 starts moving/separating from the second contact 320, the insulating medium between the two contacts 310 and 320 experiences a significantly high electric stress. The electric stress may approximately inversely proportional to a distance between the first and second contacts 310 and 320. At an instant of the separation of the first and second contacts 310 and 320, the insulating medium between the first and second contacts 310 and 320 may breakdown because of the high electric stress. The breakdown of the insulating medium may result in formation of a conducting channel or the spark between the first and second contacts 310 and 320. With the movement of the first contact 310 further away from the second contact 320, the spark is drawn along with the movement of the first contact 310. The current continues to flow between the first and second contacts 310 and 320 through the spark, and therefore the interruption of the current is not effective. The interruption of the current may be considered effective only when the spark is finally quenched/extinguished and thereby ceases to exist.

In most of cases, the first and second contacts 310 and 320 of the disconnector 300 are not specially designed and therefore the spark may start from any point on the first contact 310, i.e. from an undesirable point on the first contact 310. Such a spark/discharge may have a higher probability of leading to disruptive spark to an enclosure (i.e., ground potential). Further, it may be difficult to limit the spark to remain at the longitudinal center axis of the first contact 310. Accordingly, it may be difficult to avoid the contact of the spark with other elements of the DS that may be at the ground potential/enclosure, thereby leading to an internal spark and failure of the DS.

Therefore, according to embodiments of the present disclosure, the disconnector 300 for the electrical apparatus 200, is provided, which is designed to centralize the spark towards the longitudinal center axis of the first contact 310.

As depicted in FIG. 3, the disconnector 300 comprises the first contact 310 and the second contact 320. The first contact 310 is of a tubular shape having a longitudinal center axis. The first contact 310 may be movably arranged in a direction of the longitudinal center axis and the second contact 320 may be a fixed contact. The first contact 310 is connected to the second contact 320 in a closed position. The first contact 310 is disconnected from the second contact 320 in an open position. The first contact 310 may have an end surface directed towards the second contact 320. The first contact 310 and the second contact 320 may be placed in the closed chamber. In some examples, the closed chamber may comprise an eco-friendly gas mixture. Some examples of the eco-friendly gas mixture may comprise Nitrogen gas, N₂, Oxygen gas, O₂, Carbon dioxide, CO₂, or the same and mixtures of fluoroketones or fluoronitriles.

In some embodiments, the disconnector 300 comprises a dielectric shield (not shown) that encloses the first contact 310.

At least one of: the first contact 310 and the second contact 320 is movable in a direction along a longitudinal center axis of the first contact 310. In an example, the longitudinal center axis of the first contact 310 is same as a longitudinal centre axis of the disconnector 300. The longitudinal center axis is an imaginary line passing through the centroid of a cross-section along a long axis of any object. In another example, the longitudinal center axis could be the rotation axis of the first contact 310.

Further, at least one of the first and second contacts 310 and 320 of the disconnector 300 comprises a pre-determined contact portion 325. In embodiments disclosed herein, it is considered that the second contact 320 comprises the pre-determined contact portion 320 that has a roughness higher than a roughness of neighbouring contact portions of the second contact 320. In the open position, the pre-determined contact portion 325 of the second contact 320 is closer to the first contact 310 as compared to the neighbouring contact portions of the second contact 320. The neighbouring contact portions may be rest of the portions of the second contact 320 other than the pre-determined contact portion 325. The pre-determined contact portion 325 may be located closer to the longitudinal center axis of the first contact 310 than are located said neighbouring contact portions. In an example, the pre-determined contact portion 325 may be located at a tip of the first contact 310 such that the pre-determined contact portion 325 of the second contact 320 is closer to the first contact 310 as compared to the neighbouring contact portions of the second contact 320.

In some examples, a minimum roughness of the pre-determined contact portion 325 of the second contact 320 has an Arithmetic average roughness value, Ra of 1 microns, Total height of the roughness profile, Rt of 8 microns, and a Mean roughness depth, Rz of 4 microns. In some examples, a minimum roughness of the pre-determined contact portion 325 of the second contact 320 has an Arithmetic average roughness value, Ra of 2 microns, Total height of the roughness profile, Rt of 15 microns, and a Mean roughness depth, Rz of 7 microns.

In some examples, a minimum roughness of the pre-determined contact portion 325 of the second contact 320 has an Arithmetic average roughness value, Ra of 5 microns, Total height of the roughness profile, Rt of 30 microns, and a Mean roughness depth, Rz of 20 microns.

In some examples, a maximum roughness of the pre-determined contact portion 325 of the second contact 320 has an Arithmetic average roughness value, Ra, of 20 microns, Total height of the roughness profile, Rt, of 120 microns, and a Mean roughness depth, Rz, of 80 microns.

In some examples, a maximum roughness of the pre-determined contact portion 325 of the second contact 320 has an Arithmetic average roughness value, Ra, of 15 microns, Total height of the roughness profile, Rt, of 90 microns, and a Mean roughness depth, Rz, of 60 microns.

In some examples, a maximum roughness of the pre-determined contact portion 325 of the second contact 320 has an Arithmetic average roughness value, Ra, of 10 microns, Total height of the roughness profile, Rt, of 60 microns, and a Mean roughness depth, Rz, of 40 microns.

In some examples, the roughness of the pre-determined contact portion 325 may be increased by a method of sandblasting on the corresponding surface of the second contact 320. Sandblasting may be a mechanical surface treatment procedure consisting of projecting pellets or grains of sand or the like at a very high speed onto a material's surface. Further, the pre-determined contact portion 325 that has the increased roughness may be constituted by Aluminium or by an alloy of Aluminium. For surfaces under negative polarity, roughness may be increased by any means such as sandblasting, at a rate by which injection of electrons may be increased. Further, metals with lower evaporation temperature (such as Aluminium) may not undergo conditioning effects (reduction of roughness) by sparking in gaseous insulation under rated filling pressures. Therefore, with having the increased roughness on a shield made of Aluminium/Aluminium alloy, rate of incoming negative ions on the first contact 310 may increase where the negative ions may detach electrons to initiate the spark/discharge.

The location of the pre-determined contact portion 325 may be restricted to a centric location on the second contact 320 and if located with the help of XY axis, preferably xy %=50% and even more preferably xy %=0%.

Further, according to an example, the location of the pre-determined contact portion 325 on the second contact 320 may be defined by field-line-ends, such that the field-line-ends start at instant of first pre-strike on an axial centre of the first contact 310, with xy %=50%.

According to another example, the location of the increased roughness on the second contact 320 may be defined by field-line-ends, such that the field-line-ends start at instant of first pre-strike on an axial centre of the first contact 310, with xy %=30%.

Advantageously, by limiting the pre-determined contact portion 325 to a specific location that is connected via field-line-ends towards a location where the spark/discharge may start, a risk of centric sparks/discharges at positive polarity is reduced.

For the spark/discharge to establish, a first electron to start an electron avalanche is needed. The second contact 320 is configured to initiate the spark or to cause pre-strike and re-strike discharge, during the movement of the first contact 310, from a specific region 330 that is an inner surface of the first contact 310, as depicted in FIG. 3. The initiation of the spark is achieved by targeted bombardment on the specific region 330 of the first contact 310 with ions (not shown in FIG. 3) that are negatively charged. The ions stem from the pre-determined contact portion 325 of the second contact 320, thereby to centralize a path of the spark/discharge closer to the longitudinal center axis of the first contact 310. In an example, the specific region 330 of the first contact 310 is close/near to a centre of the first contact 310, and the specific region 330 is a tip of the first contact 310. The ions drift with direction of electric field towards the specific region 330 of the first contact 310, and provoke the discharge at the specific region 330 by increasing a field gradient at the specific region 330 to a value greater than a field gradient of other regions of the first contact 310.

Thus, by provoking the discharge to start at the pre-determined contact portion 325, which is close to the longitudinal center axis of the first contact 310, centring of the spark/discharge generated between the at least two contacts 310 and 320 towards the longitudinal center axis is achieved. Advantageously, a risk of spark spreading is minimized and thereby risk of DS failure is eliminated.

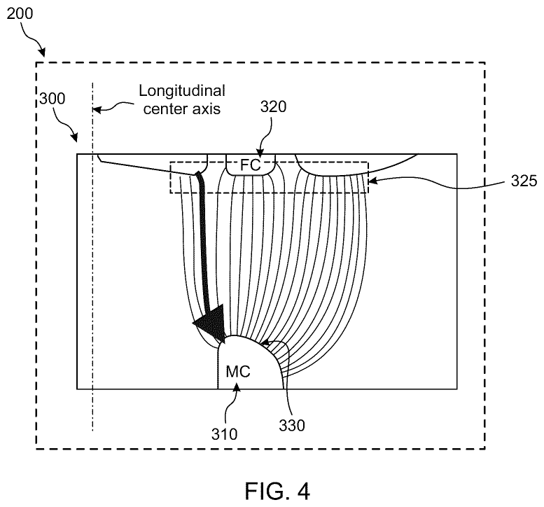

FIG. 4 discloses a schematic diagram of an example cross-section of a disconnector 300 adapted for an electrical apparatus 200. The electrical apparatus 200 may be a disconnector switch, DS, or any other similar switching device. The disconnector 300 comprises the at least two contacts, a first contact 310 that may be a moving contact, MC, and a second contact 320 that may be a fixed contact, FC. In an example, the MC 310 is movable in the direction of the longitudinal center axis of the disconnector 300. In an example, the longitudinal center axis of the disconnector 300 is same as the longitudinal center axis of the two contacts 310 and 320 (as indicated in the FIG. 4). The MC 310 being connected to the FC 320 in a closed position of the DS, and disconnected from the FC 320 in an open position.

As depicted in FIG. 4, when the MC 310 starts moving/separating from the FC 320, a spark (i.e., pre-strike or restrike discharges) is drawn along with the movement of the MC 310. The FC 320 comprises a pre-determined contact portion 325 that has a roughness higher than a roughness of neighbouring contact portions in the FC 320. The neighbouring contact portions may not be designed to have an increased roughness. The pre-determined contact portion 325 may be located closer to the longitudinal center axis of the MC 310 than are located said neighbouring contact portions. Further, as depicted in FIG. 4, the pre-determined contact portion 325 may be located at the tip of the FC 320 and therefore the pre-determined contact portion 325 of the FC 320 is closer to the MC 310 as compared to the neighbouring contact portions of the FC 320.

The FC 320 is configured to initiate the spark or to cause the pre-strike and re-strike discharges, during the movement of the MC 310, from a specific region 330 of the MC 310, by targeted bombardment on the specific region 330 of the MC 310 with negatively charged ions, and allowing the ions to stem from the pre-determined contact portion 325 of the FC 320. Thereby to centralize path of the spark/discharge closer to the longitudinal center axis of the MC 310. The MC 310 may have an end surface directed towards the FC 320. In an example, the inner surface of the MC 310 may be close to a centre of the MC 310 and may be a tip of the MC 310.

As depicted in FIG. 4, the bold arrow directing from the FC 320 towards the MC 310 indicates a path of an ion generated at the pre-determined contact portion 325 of the FC 320. Paths similar to the bold arrow is followed by the negatively charged ions that stem from the pre-determined contact portion 325. Ion production is provoked in the pre-determined contact portion 325. The ions drift with a direction of electric field present between the MC 310 and the FC 320, to reach to the specific region 330 that is an inner surface of the MC 310, where the ions increase a field gradient/electric field strength to provoke the spark/discharge form the specific region 330. Accordingly, the initiation of the spark is achieved by targeted bombardment of the negatively charged ions on the specific region 330 of the MC 310. Since, the pre-determined contact portion 325 as well as the specific region 330 are located near to the longitudinal center axis of the disconnector 300, the generated spark is centralized.

Therefore, by increasing the roughness of the pre-determined contact portion 325 and locating the pre-determined contact portion 325 closer to the longitudinal center axis of the MC 310, the spark is shifted more towards the longitudinal center axis, i.e. towards the centre of the MC 310 and not migrated towards an enclosure (i.e., ground potential). As a result, any unintentional contact of the spark with any other elements of the electrical apparatus 200 or DS is reduced, thereby eliminating risk of failure of the electrical apparatus 200 or the DS. The longitudinal center axis is an imaginary line passing through the centroid of a cross-section along a long axis of any object. In an example, the longitudinal center axis could be the rotation axis of the first contact 310.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1-15. (canceled)

16. A disconnector for an electrical apparatus, the disconnector comprising:
a first contact having a longitudinal center axis; and
a second contact, wherein at least one of the first contact and the second contact is movable in a direction of the longitudinal center axis of the first contact, wherein the first contact is connected to the second contact in a closed position, wherein the first contact is disconnected from the second contact in an open position, wherein the second contact comprises a pre-determined contact portion that has a roughness higher than a roughness of neighbouring contact portions of the second contact, and wherein the pre-determined contact portion is closer to the longitudinal center axis of the first contact than are said neighbouring contact portions,
wherein a minimum roughness of the pre-determined contact portion of the second contact has an Arithmetic average roughness value (Ra) of 1 microns, Total height of the roughness profile (Rt) of 8 microns, and a Mean roughness depth (Rz) of 4 microns.

17. The disconnector according to claim 16, wherein a minimum roughness of the pre-determined contact portion of the second contact has an Arithmetic average roughness value, Ra of 2 microns, Total height of the roughness profile, Rt of 15 microns, and a Mean roughness depth, Rz of 7 microns.

18. The disconnector according to claim 16, wherein a minimum roughness of the pre-determined contact portion of the second contact has an Arithmetic average roughness value, Ra of 5 microns, Total height of the roughness profile, Rt of 30 microns, and a Mean roughness depth, Rz of 20 microns.

19. The disconnector according to claim 16, wherein a maximum roughness of the pre-determined contact portion of the second contact has an Arithmetic average roughness value, Ra, of 20 microns, Total height of the roughness profile, Rt, of 120 microns, and a Mean roughness depth, Rz, of 80 microns.

20. The disconnector according to claim 16, wherein a maximum roughness of the pre-determined contact portion of the second contact has an Arithmetic average roughness value, Ra, of 15 microns, Total height of the roughness profile, Rt, of 90 microns, and a Mean roughness depth, Rz, of 60 microns.

21. The disconnector according to claim 16, wherein a maximum roughness of the pre-determined contact portion of the second contact has an Arithmetic average roughness value, Ra, of 10 microns, Total height of the roughness profile, Rt, of 60 microns, and a Mean roughness depth, Rz, of 40 microns.

22. The disconnector according to claim 16, wherein the first contact has an end surface directed towards a second contact, and wherein in said open position, the pre-determined contact portion of the second contact is closest to the first contact as compared to the neighbouring contact portions of the second contact.

23. The disconnector according to claim 16, wherein the first contact is movably arranged in the direction of the longitudinal center axis, and wherein the second contact is a fixed contact.

24. The disconnector according to claim 16, wherein the pre-determined contact portion having the increased roughness is constituted by an Aluminium alloy.

25. The disconnector according to claim 16, wherein the pre-determined contact portion having the increased roughness is defined by a circular area having a center axis, which is in alignment with the longitudinal center axis of the first contact, and wherein the circular area has a radius, which is less than a radius of an outer periphery of the first contact.

26. The disconnector according to claim 16, wherein a radius of the pre-determined contact portion is less than a radius of an inner periphery of the first contact.

27. The disconnector according to claim 16, comprising a dielectric shield that encloses the first contact.

28. The disconnector according to claim 16, comprising an insulating medium between the first contact and the second contact, wherein the insulating medium comprises at least one of Sulphur hexafluoride, SF₆, air, Carbon dioxide, CO₂, Oxygen, O₂, a fluoroketone mixture, and a nitrile mixture.

29. The disconnector according to claim 16, wherein one or more of the first contact and the second contact is of tubular shape.
